(19) United States
(12) Patent Application Publication
(10) Pub. No.: US 2013/0213873 A1
(43) Pub. Date: Aug. 22, 2013

(54) DEVICE FOR PRECIPITATING SUSPENDED MATERIALS

(71) Applicant: Ditmar Stemmer, Oberkirch (DE)

(72) Inventor: Ditmar Stemmer, Oberkirch (DE)

(73) Assignee: BDT GMBH, GESELLSCHAFT FUER GERAETETECHNIK, Offenburg (DE)

(21) Appl. No.: 13/824,472

(22) PCT Filed: Sep. 14, 2011
(86) PCT No.: PCT/EP2011/065931

§ 371 Date: Apr. 1, 2013

(30) Foreign Application Priority Data
Oct. 11, 2010 (DE) 10 2010 047 904.7

(51) Int. Cl. C02F 1/52

(52) U.S. Cl. CPC C02F 1/52
USPC 210/252

(57) ABSTRACT

A device for precipitating suspended materials from a liquid, in particular for precipitating gypsum from water, having a vessel comprising a liquid inlet and a liquid outlet, and subdivided into chambers that are in sequence in the flow direction by means of partitions, wherein the liquid inlet opens into a first of the chambers and the liquid outlet opens into a last of the chambers. At least one part of the chambers and preferably every chamber communicates with the chamber downstream thereof in the flow direction by means of an opening in the partition disposed between the chambers. The opening extends at a distance from and parallel to an upper edge of the partition, and each of the openings is disposed at a greater distance from the vessel floor than the opening in the partition downstream thereof in the flow direction.

The invention relates to an apparatus for precipitation of suspended materials from a liquid, in accordance with the preamble of claim 1.

Such a precipitation apparatus is known, for example, from DE 296 21 590 U1. It has a container that is divided into four chambers by means of four partition walls. Toward the top, the container is closed off by means of a lid that lies on a first partition wall. The second partition wall, which delimits the first chamber together with the first partition wall, is slightly lower than the first partition wall, so that its top edge is disposed at a distance from the lid. The third partition wall, which delimits the second chamber together with the second partition wall, is in turn slightly lower than the second partition wall; the fourth partition wall, in turn, is lower than the third partition wall. The liquid contaminated with suspended materials, particularly waste water of a dental technology laboratory contaminated with gypsum residues, is introduced into the first chamber by way of an inlet for liquid.

Once the first chamber is filled, further water from the first chamber flows over the top edge of the second partition wall into the second chamber. Once the second chamber is filled, further water flows over the top edge of the third partition wall into the third chamber, and when this chamber is completely filled, it flows over the top edge of the fourth partition wall into the fourth chamber. The suspended materials precipitate in each of the chambers, until finally, water that flows into the fourth chamber is freed of suspended materials, to a high degree, and has therefore been pre-cleaned. The pre-cleaned water is passed out of the fourth chamber by means of an outlet for liquid.

The previously known gypsum precipitation apparatus has already proven itself excellently in practice, and leads to precipitation of up to 70% of suspended gypsum materials contained in the water that is introduced. Proceeding from the previously known state of the art, it is the task of the invention to further develop a precipitation apparatus of the type indicated initially, in such a manner that its degree of precipitation is increased even further.

This task is accomplished, according to the invention, with an apparatus having the characteristics of claim 1. Advantageous further developments of the invention are the object of the dependent claims.

The invention is based on the idea that the degree of precipitation for suspended materials is increased if the flow velocity of the liquid that contains the suspended materials is slowed down from one chamber to the following chamber. Slowing down of the flow velocity is achieved, according to the invention, in that the chambers are connected with one another by openings that are disposed at a distance from the top edge of the partition wall, in each instance. In this manner, the openings can be kept narrow, so that they have only a slight height and slow the flow velocity down. This is particularly advantageous if liquid is introduced into the container in surge-like manner, for example by means of emptying a sink by way of a drain, and in the case of non-braked passage from one chamber to the next, suspended materials that have already settled at the bottom or close to the bottom would be swirled up again. This is because the openings, which are preferably configured as narrow gaps, slow the flow velocity down, so that if applicable, a backup already occurs when the liquid is introduced into the container, and the liquid is slowly introduced into the first chamber.

It is practical if the width of the openings is at least five times, preferably at least ten times as great as their height. In this connection, it is preferred that all the openings have identical dimensions. However, it is also possible that the openings are of different sizes. Furthermore, it can be provided, for example, that the opening between the first and the second chamber is open, with its edge, toward the top edge of the partition wall situated between the two chambers.

It is practical if the partition walls are disposed, in a top view, in star shape, and extend from a center axis of the container all the way to the side walls of the container. Then, a partition wall that has no opening is disposed between the last and the first chamber, in order to avoid direct inflow of liquid from the first chamber into the last chamber. It is advantageous if four partition walls are provided, whereby two partition walls, in each instance, that are disposed at an angle of 180° relative to one another, are connected in one piece, and whereby the pairs of partition walls are assembled by means of slots that run perpendicular between the partition walls. This allows easy assembly of the partition walls. In this connection, it is preferred that the slots run over half the height of the pairs of partition walls, in each instance, specifically from the bottom in the case of one pair of partition walls and from the top in the case of the other pair of partition walls.

It is practical if the container has a lid that lies on the top edges of the partition walls. This prevents the liquid from sloshing over the top edges of the partition walls. If the lid has profiles on its underside that engage around the top edges of the partition walls, a better sealing effect between the lid and the partition walls is obtained. The container is preferably lined with a film into which the partition walls are inserted. The film can then serve as a waste container for disposing of the precipitated suspended materials.

In the following, the invention will be explained in greater detail using an exemplary embodiment shown schematically in the drawing. This shows

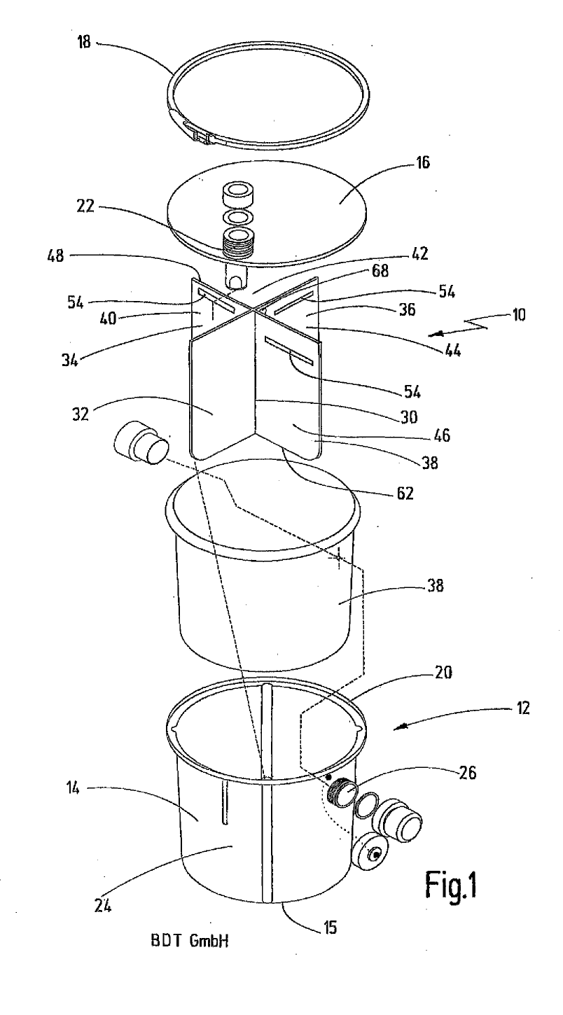

FIG. 1 a precipitation apparatus for gypsum in an exploded representation;

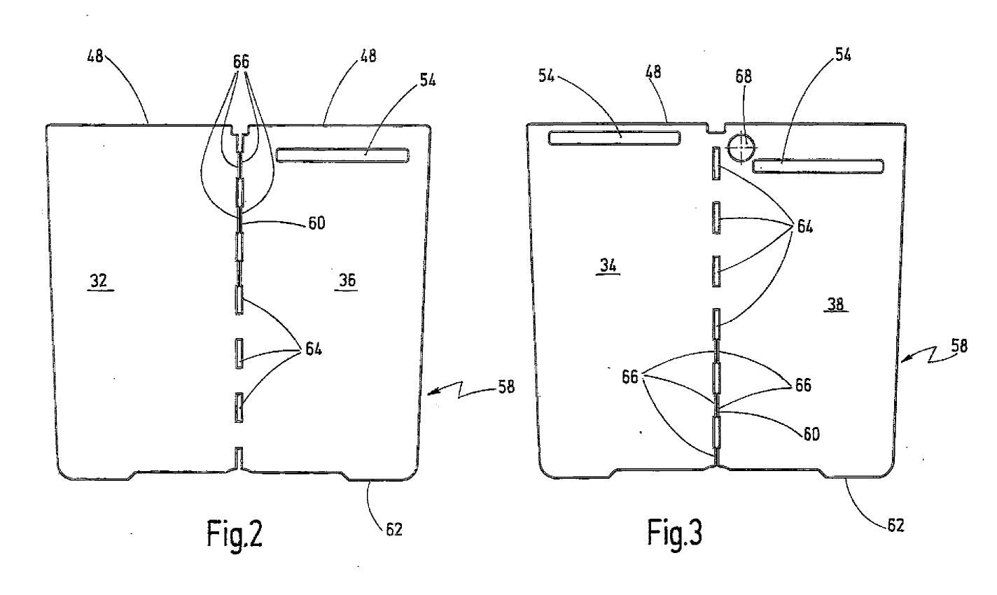

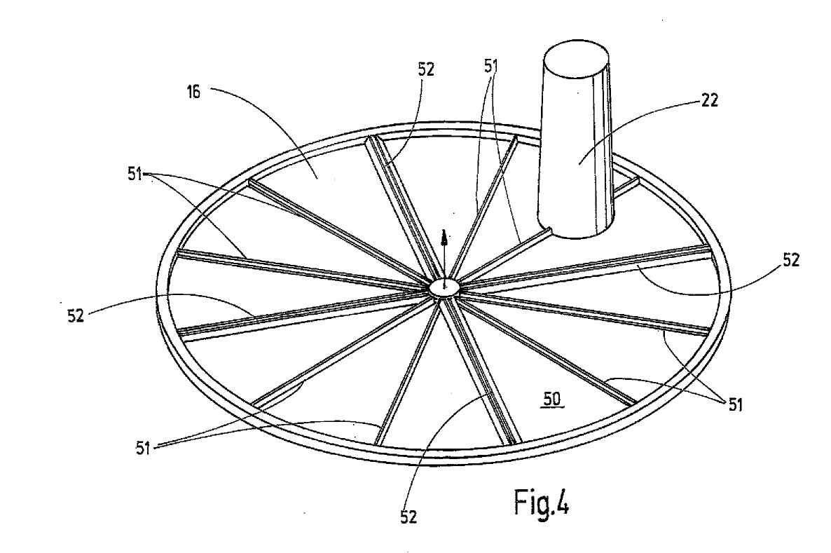

FIGS. 2, 3 two pairs of partition walls of the apparatus according to FIG. 1; and

FIG. 4 the lid of the apparatus according to FIG. 1 in a view from below.

The precipitation apparatus 10 shown in the drawing has a container 12 that has a cylindrical, pot-like lower part 14 having a bottom 15 and a lid 16. The lid is attached to a circumferential edge 20 of the lower part 14 by means of a clamping ring 18. An inlet connector 22 for liquid is disposed in the lid 16, while an outlet connector 26 is disposed in the cylinder wall 24 of the lower part 14.

A film 28, also approximately cylindrical, is inserted into the lower part 14, lining the lower part 14, and through which the outlet connector 26 passes. The interior of the container 12 is divided into four chambers 40, 42, 44, 46 by means of four partition walls 32, 34, 36, 38 that extend radially outward from a center axis 30. The inlet connector 22 is situated above the first chamber 40, which is followed in the clockwise direction by the further chambers 42, 44, 46, in this order. The outlet connector 26 opens into the last chamber 46.

The lid 16 lies on the top edges 48 of the partition walls 32, 34, 36, 38 and has, on its underside 50, not only stabilization struts 51 but also four profiles 52 that are U-shaped in cross-section and engage around the top edges 48. In this way, sloshing of liquid over the top edges 48 is avoided, to a great extent. The second partition wall 34 has an opening in the form of an elongated gap that runs parallel to the top edge 48 and connects the first chamber 40 with the second chamber 42, at a distance from its top edge 48. An identical opening 54 is disposed in the third partition wall 36, but is situated at a greater distance from the top edge 48 than the opening 54 in the second partition wall 34. An identical opening 54 is disposed in the fourth partition wall 38, at an even greater distance from the top edge 48. The openings 54 connect the chambers 40, 42, 44, 46 with one another. The first partition wall 32 does not have any opening, so that no connection exists between the first chamber 40 and the fourth chamber 46. The openings 54 are therefore situated, viewed in the flow direction from the inlet connector 22 to the outlet connector 26, at a decreasing height above the container bottom 15.

If a liquid contaminated with suspended materials, for example waste water of a dental technology laboratory contaminated with gypsum, of waste water of a pottery contaminated with clay residues, is introduced into the first chamber 40 by way of the inlet connector 22, then this chamber is filled until the water is standing up to the height of the opening 54 in the second partition wall 34. The suspended materials then gradually settle to the bottom or close to the bottom in the resting water. If further water is introduced, then water flows into the second chamber 42, by way of the opening 54 in the second partition wall 34, until this chamber is filled up to the height of the opening 54 in the third partition wall 36, etc. Once the fourth chamber 46 has also been filled to a height at which the outlet connector 26 is situated, then water is conducted away by way of the outlet connector 26. For this purpose, the outlet connector 26 is situated maximally at the same height above the container bottom 15 as the opening 54 in the fourth partition wall 38. The suspended materials settle at the bottom of all four chambers 40, 42, 44, 46. The openings 54, which are kept very narrow, limit the flow velocity of the water when passing from one chamber to the next, so that suspended materials that have already been precipitated are not swirled up again, or only to a slight degree.

The partition walls 32, 34, 36, 38 are shown in detail in FIGS. 2, 3. The first and the third partition wall 32, 36 are connected in one piece to form a first pair 56 of partition walls (FIG. 2), while the second and the fourth partition wall 34, 38 are connected in one piece to form a second pair 48 of partition walls (FIG. 3). The first pair 56 of partition walls has a slot 60 between the partition walls 32, 36 that extends over half its height, proceeding from the top edge 48, while the second pair 58 of partition walls has a similar slot 60 that, in contrast, extends from a bottom edge 62 between the partition walls 34 and 38. Perforations 64 are situated in the extension of the slots 60, in each pair 56, 58 of partition walls, into which perforations projections 66 in the region of the slot 60 of the other pair of partition walls, in each instance, engage, so that the pairs 56, 58 of partition walls are meshed with one another to form the star-shaped arrangement shown in FIG. 1. The partition walls 32, 34, 36, 38 can furthermore be provided, above their opening 54, with a handle hole 68 to make them easier to grip. Such a handle hole 68 is shown in FIG. 1, in the third partition wall 36, and in FIG. 3, in the fourth partition wall 38.

In summary, the following should be stated: The invention relates to an apparatus 10 for precipitation of suspended materials from a liquid, particularly for precipitation of gypsum from water, having a container 12, which has an inlet 22 for liquid and an outlet 26 for liquid, and which is divided, by means of partition walls 32, 34, 36, 38, into multiple chambers 40, 42, 44, 46 that follow one another in a flow direction, wherein the inlet 22 for liquid opens into a first one of the chambers 40, and wherein the outlet 26 for liquid opens into a last one of the chambers 46. According to the invention, it is provided that at least a part of the chambers 40, 42, 44, 46 and preferably each chamber 40, 42, 44, 46 communicates with the chamber 42, 44, 46 that follows it in the flow direction by means of an opening 54 in the partition wall 34, 36, 38 disposed between the chambers 42, 44, 46, wherein the opening 54 runs at a distance from and parallel to a top edge 48 of the partition wall 34, 36, 38, and that each of the openings 54 is disposed at a greater distance from the container bottom 15 than the opening 54 in the partition wall 36, 38 that follows in the flow direction.

1-9. (canceled)

10. An apparatus for precipitation of suspended materials from a liquid, particularly for precipitation of gypsum from water, comprising a container having an inlet for liquid and an outlet for liquid, and which is divided, by means of partition walls, into multiple chambers that follow one another in a flow direction,
wherein the inlet for liquid opens into a first one of the chambers and the outlet for liquid opens into a last one of the chambers,
wherein at least some the chambers communicate with a following one of the chambers by means of an opening in the partition wall disposed between the chambers,
wherein the opening runs at a distance from and parallel to a top edge of the partition wall,
wherein each of the openings is disposed at a greater distance from a container bottom than the opening in the partition wall that follows in the flow direction,
wherein the partition walls are disposed, in a top view, in star shape, and extend from a center axis of the container all the way to one or more side walls of the container,
wherein a partition wall without an opening is disposed between a last one of the chambers and a first one of the chambers, and
wherein four partition walls are provided, forming two pairs of partition walls, such that each pair of partition walls is disposed at an angle of 180° relative to one another and is connected in one piece, and
wherein the pairs of partition walls are assembled by means of slots that run perpendicular between the partition walls.

11. The apparatus according to claim 10, wherein the openings have a width that is at least five times as great as its height.

12. The apparatus according to claim 10, wherein the openings have identical dimensions.

13. The apparatus according to claim 10, wherein the slots run over half a height of the pairs of partition walls.

14. The apparatus according to claim 10, wherein the container has a lid that lies on the top edges of the partition walls.

15. The apparatus according to claim 14, wherein the lid has profiles on its underside, which engage around the top edges of the partition walls.

16. The apparatus according to claim 10, wherein the container is lined with a film into which the partition walls are inserted.
